(19) United States
(12) Patent Application Publication
(10) Pub. No.: US 2013/0067331 A1
(43) Pub. Date: Mar. 14, 2013

(54) Method and System of Simultaneous Display of Multiple Screens on a Target Display

(71) Applicants: Joshua Glazer, Ra'anana (IL); Yuval Luzon, Akko (IL); Matan Shapira, Kfar Saba (IL); Leonid Liansky, Maple (CA)

(72) Inventors: Joshua Glazer, Ra'anana (IL); Yuval Luzon, Akko (IL); Matan Shapira, Kfar Saba (IL); Leonid Liansky, Maple (CA)

(73) Assignee: SCREENOVATE TECHNOLOGIES LTD., Raanana (IL)

(21) Appl. No.: 13/603,747

(22) Filed: Sep. 5, 2012

Related U.S. Application Data
(60) Provisional application No. 61/532,804, filed on Sep. 9, 2011.

(51) Int. Cl. G06F 3/048; G06F 15/16

(52) U.S. Cl. 715/719

(57) ABSTRACT

The present invention discloses a method for simultaneous display and activation of at least one video and at least one interactive application on a target display. The method comprises the steps of: streaming data of the computerized device to the target display, displaying data of the computerized device on the target display in full screen mode, activating a video on the computerized device, determining display settings of the video and the computerized device at the target display, streaming the video data to the target display, displaying the video stream on the screen simultaneously with the computerized device according to determined settings, receiving user selection of at least one interactive application, determining display settings of the video and the interactive application at the target display, streaming the selected interactive application display data to the target display, displaying the video stream on the screen simultaneously with interactive application according to determined setting.

### CROSS-REFERENCE TO RELATED PATENT APPLICATIONS

This application claims priority to Provisional patent application No. 61/532,804 filed on Sep. 9, 2011, which is incorporated herein by reference in its entirety.

### BACKGROUND

### Technical Field

The present invention generally relates to the field of streaming application screen Graphical User Interface (GUI) data and more specifically streaming of multiple application screens GUI.

### BRIEF SUMMARY

The present invention provides a method for simultaneous displaying and activating of at least one video and at least one interactive application on a target display. The method comprises the steps of: streaming data of at least one computerized device screen menu Graphical User Interface (GUI) to a target device of the target display, displaying the data of the computerized device screen menu GUI on the target display in a predefined portion of the target display; activating at least one video, determining display settings of the at least one video and the at least one computerized device screen menu GUI at the target display and displaying the at least one video on the target display simultaneously with the at least one computerized device screen menu GUI according to determined settings

The at least one computerized device screen menu GUI covers a portion of the target display and is displayed above at least one video display.

According to some embodiments of the present invention the method further comprises the steps of: receiving a selection of at least one interactive application from a user, determining display settings of the video and the at least one interactive application over the target display, streaming data of the selected one or more interactive applications display to the target device of the target display and displaying the video stream on the target display simultaneously with the at least one interactive application according to determined settings. The changing the display portion of the interactive application and video according to triggering events or configuration performed by the user.

According to some embodiments of the present invention the video is activated by the target device of the target display.

According to some embodiments of the present invention the video is activated by the computerized device.

According to some embodiments of the present invention the video is displayed in a partial portion of the target display.

According to some embodiments of the present invention the video is activated by the computerized device.

According to some embodiments of the present invention the video is activated by the target device of the target display.

According to some embodiments of the present invention the video is located remotely and is being streamed directly to the target device via a communication network link.

According to some embodiments of the present invention the streaming includes blending frames from the activated video with frames from the screen menu GUI, such as the frame from screen menu GUI is on top of the frame of the activated video covering only a portion of the target display according to a predefined layout configuration.

The present invention discloses a streaming application for simultaneous display and activation of at least one video and at least one interactive application on a target display, The streaming application is comprised of: a streaming management module for streaming data of at least one computerized device screen menu Graphical User Interface (GUI) to a target device of the target display, an activation module for displaying the data of the computerized device screen menu GUI on the target display in a predefined portion of the target display; and a display screen layout management module for displaying the at least one video on the target display simultaneously with the at least one computerized device screen menu GUI according to determined settings.

According to some embodiments of the present invention the streaming application has a user control GUI.

According to some embodiments of the present invention the activation module is further displaying the video stream on the target display simultaneously with the at least one interactive application according to determined settings, and wherein the at least one interactive application screen is displayed above the video display.

According to some embodiments of the present invention the streaming management module is further streaming data of the selected one or more interactive applications display to the target device of the target display.

According to some embodiments of the present invention the display screen layout management module is further changing the display portion of the interactive application and video according to triggering events or configuration performed by a user.

According to some embodiments of the present invention the streaming management module is further blending frames from the activated video with frames from the screen menu GUI, such as the frame from the screen menu GUI is on top of the frame of the activated video covering only a portion of the target display according to a predefined layout configuration.

According to some embodiments of the present invention the streaming includes blending frames from the activated video with frames from the screen menu GUI, such as the frame from screen menu GUI is on top of the frame of the activated video covering only a portion of the target display according to a predefined layout configuration.

### BRIEF DESCRIPTION OF THE DRAWINGS

The present invention will be more readily understood from the detailed description of embodiments thereof made in conjunction with the accompanying drawings of which:

FIG. 1 is a block diagram, illustrating the modules of a streaming application, according to some embodiments of the invention;

FIGS. 2A and 2B are flowcharts illustrating a process of an activation module, according to some embodiments of the invention;

FIG. 3 is a flowchart illustrating a process of a display screen GUI layout management module, according to some embodiments of the invention;

FIG. 4 is a block diagram illustrating a first example of the screen GUI display on a computerized device and on a target display according to some embodiments of the invention;

FIG. 5 is a block diagram illustrating a second example of a screen GUI display on a computerized device and on a target display, according to some embodiments of the invention;

FIG. 6 is a flowchart illustrating a process of combining the computerized device screen GUI and streaming the video by the target display, according to some embodiments of the invention; and

FIG. 7 is a flowchart illustrating a process of combining a computerized device screen GUI and streaming a video by the computerized device, according to some embodiments of the invention.

### DETAILED DESCRIPTION

Before explaining at least one embodiment of the invention in details, it is to be understood that the invention is not limited in its application to the details of construction and the arrangement of the components set forth in the following description or illustrated in the drawings. The invention is applicable to other embodiments and/or may be practiced or carried out in various ways. Also, it is to be understood that the phraseology and terminology employed herein is for the purpose of description and should not be regarded as limiting.

The present invention, in some embodiments thereof, discloses a method and a system for streaming simultaneously two types of screens: a video and an interactive application screen Graphical User Interface (GUI) from a computerized device to a target display. Optionally, the video is activated on a mobile device or a computerized device and projected on the target display. The streaming of the screens' GUI may be transmitted via wired or wireless connection.

The term “target display” as used herein in this application is defined as a display monitor for playing images or video such a Television (TV) screen, or a computerized device screen.

The term “screen GUI” as used herein in this application is define as data and appearance of application screens such as messaging application screen or an application screen.

The application refers to a computerized device as an example and may be implemented to any multimedia device such as tablet computer, laptop computer or any other computerized device.

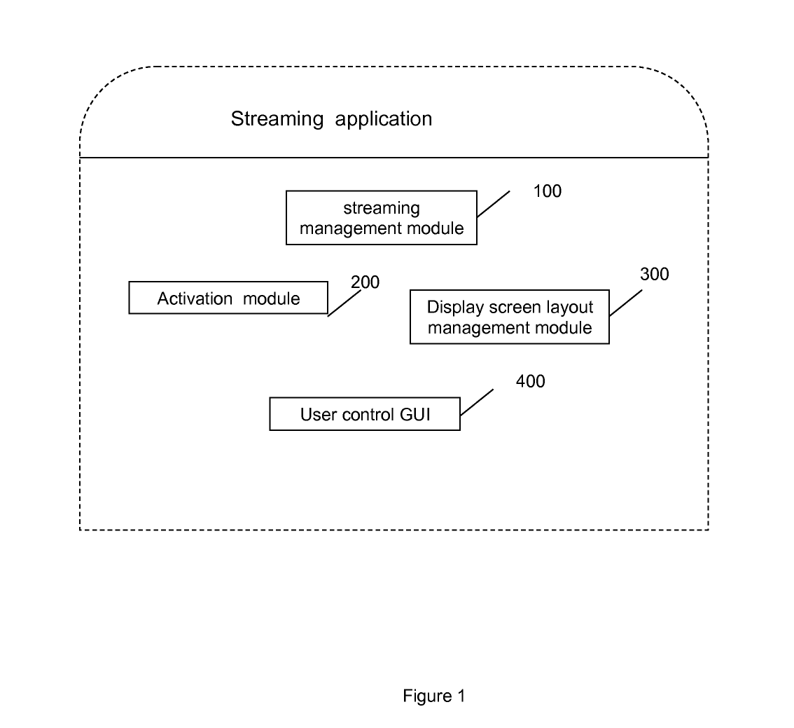

FIG. 1 is a block diagram illustrating modules of a streaming application, according to some embodiments of the invention. The streaming application is comprised of: (i) a streaming management module 100 enabling to retrieve data of an application screen Graphical User Interface (GUI) that is running on a computerized device and stream the data of screen GUI thereof, to be displayed on a target display such as a TV screen; (ii) an activation module 200 enabling simultaneous display of: a video and an interactive application screen GUI on the target display; (iii) a display screen layout management 300 module for determining the layout and settings of multiple screen mode display; and (iv) a user control GUI enabling the user to change the layout of the screens' GUI according to their preferences.

The streaming management module 100 may use any methodology known in the art of streaming multimedia data between a source device, such as a computerized device to any terminal screen such as a Television (TV) screen. In a non limiting example, the computerized device may be a mobile computerized device.

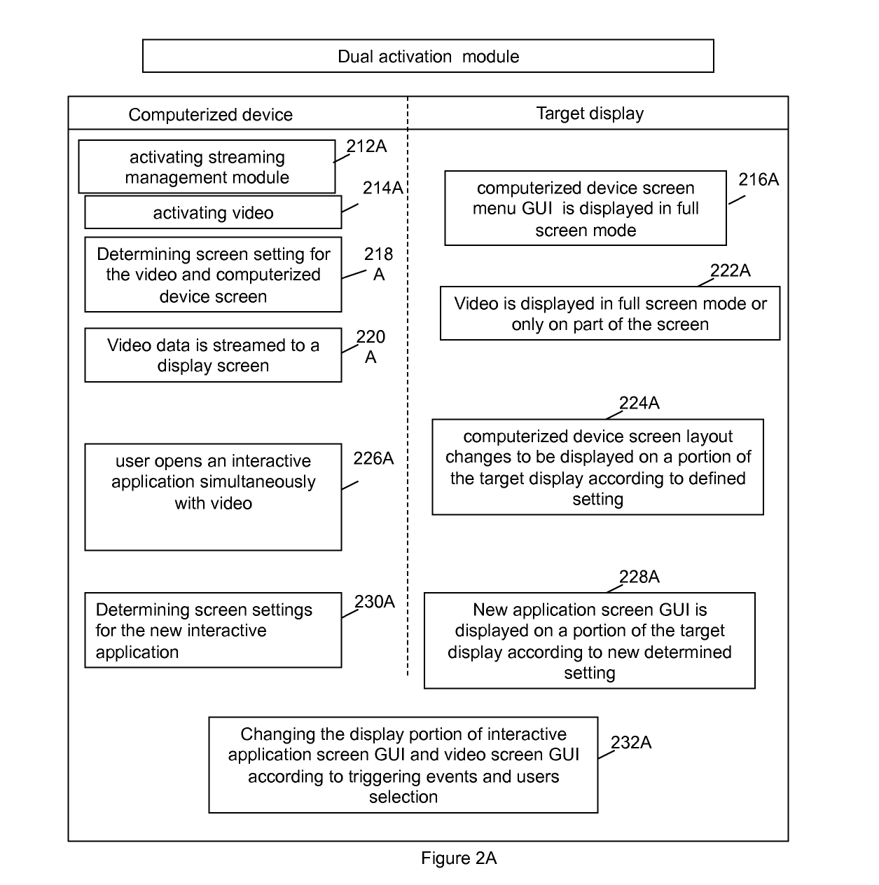

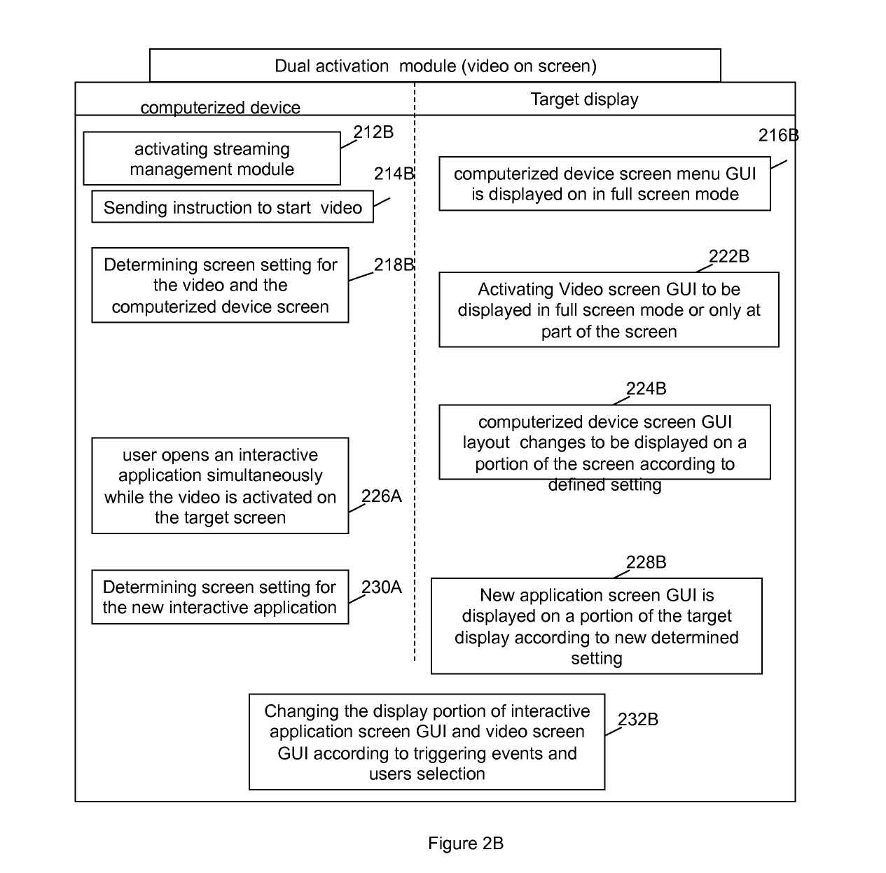

FIGS. 2A and 2B are flowcharts schematically illustrating a process of an activation module, according to some embodiments of the invention.

FIG. 2A illustrates one optional embodiment, in which the video is activated by the computerized device. FIG. 2B illustrates one optional embodiment, in which the video is activated by the target display. Once the streaming management module is activated (step 212A, 212B), the computerized device menu screen GUI is displayed on the target display (step 216A, 216B). Upon identifying user activation of a video (step 214A, 214B) optionally the video may be located on a remote server and may be activated via a website such as YouTube (www.youtube.com), or alternatively, the video may be stored locally. The module determines the layout design for displaying the video and the computerized device menu screen GUI on the target display, simultaneously (step 218A,218B).

The video is streamed to the target display (220A) or played on the target display (222B). By default, the video is displayed in full screen mode (step 222). Optionally, the video may be displayed only on a predefined portion of the target display and the computerized device menu screen GUI may be displayed on a portion of the target display. Optionally, the computerized device menu screen GUI may be located above the video display on the target display (step 224A, 224B). Optionally, the computerized device screen GUI is smaller than the video display on the target display.

The layout may change in accordance with preferences of a user. The user may be able to open a new interactive application by the computerized device (step 226A, 226B), before or during streaming of the screen GUI data of the application. The layout settings for displaying the interactive application may be determent by the user (step 230A, 230B). By default, the new interactive application may be displayed on a portion of the target display on top of the video display on the target display (step 228A, 228B). The new interactive application may be displayed on a small portion of the target display or alternatively the video may be displayed on a small portion of the target display. The display portion may be changed according to user's selections or predefined rules based on application events. In case the computerized device is a mobile computerized device, an event may be an incoming phone call (step 232A, 232B).

The steps of determining screen settings for the video and computerized device screen (step 218A, 218B) and determining screen settings for the new interactive application (step 230A, 230B) may be performed by the computerized device or optionally by the target device. When processed by the computerized device, the display screen layout management module is being activated in the computerized device and the results of the layout design are streamed to the target device and displayed on the target display.

When these steps are processed by the activation module in the target display, the display screen layout management module is being activated in the target device.

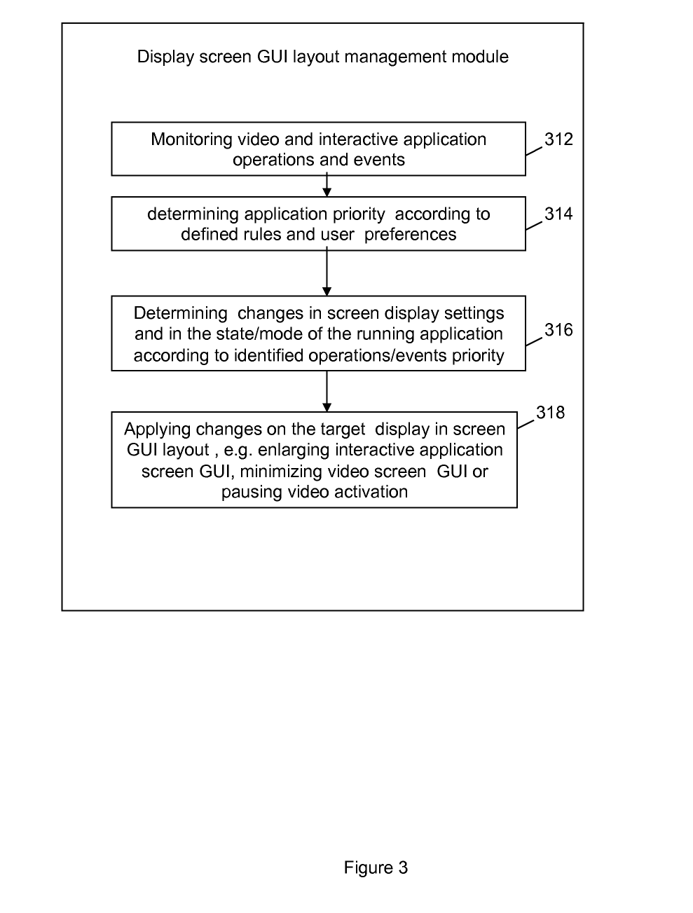

FIG. 3 is a flowchart schematically illustrating a process of a display screen layout management module, according to some embodiments of the invention. The display screen layout management module monitors and evaluates the video and the interactive application operations and events (step 312) for determining priorities between the video and the interactive application (step 314). Based on predefined rules and priorities the display screen layout management module may determine and change the display layout and settings of the application screen GUI and the video display on the target display.

Optionally, the display screen layout management module determines the changes of the activation mode of the interactive applications or the video. For example, muting the video or activating messaging application upon receipt of an electronic message such as Short Messaging Service (SMS) message, chat message, email etc (steps 316 and 318). The predefined rules may relate any application which originates notifications such as scheduling applications, Voice Over IP (VOIP) applications, news updates applications etc.

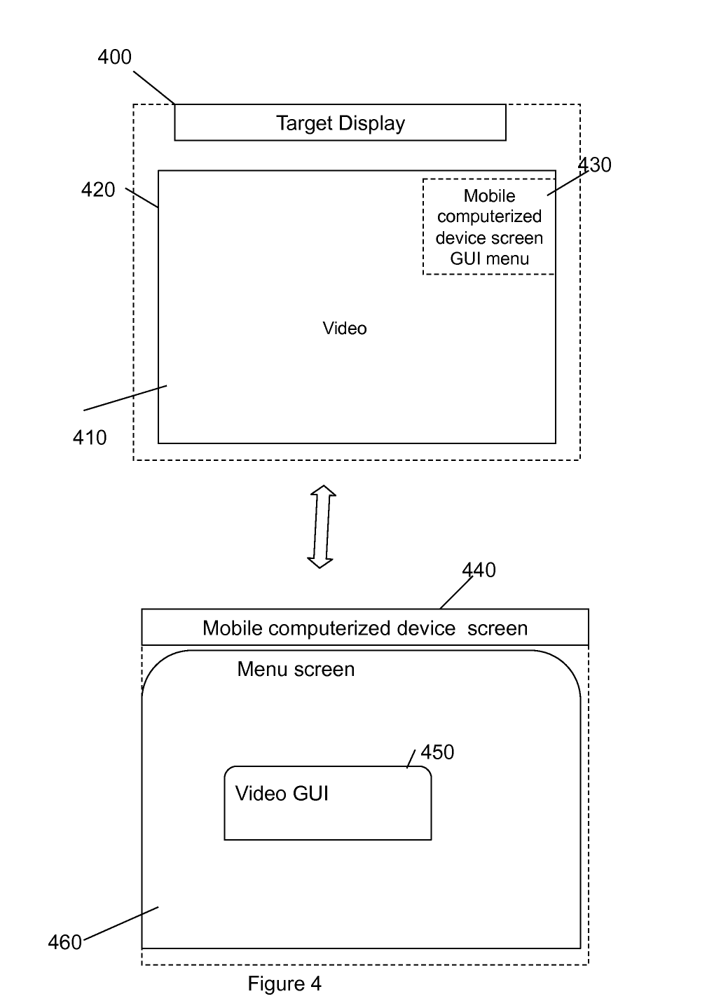

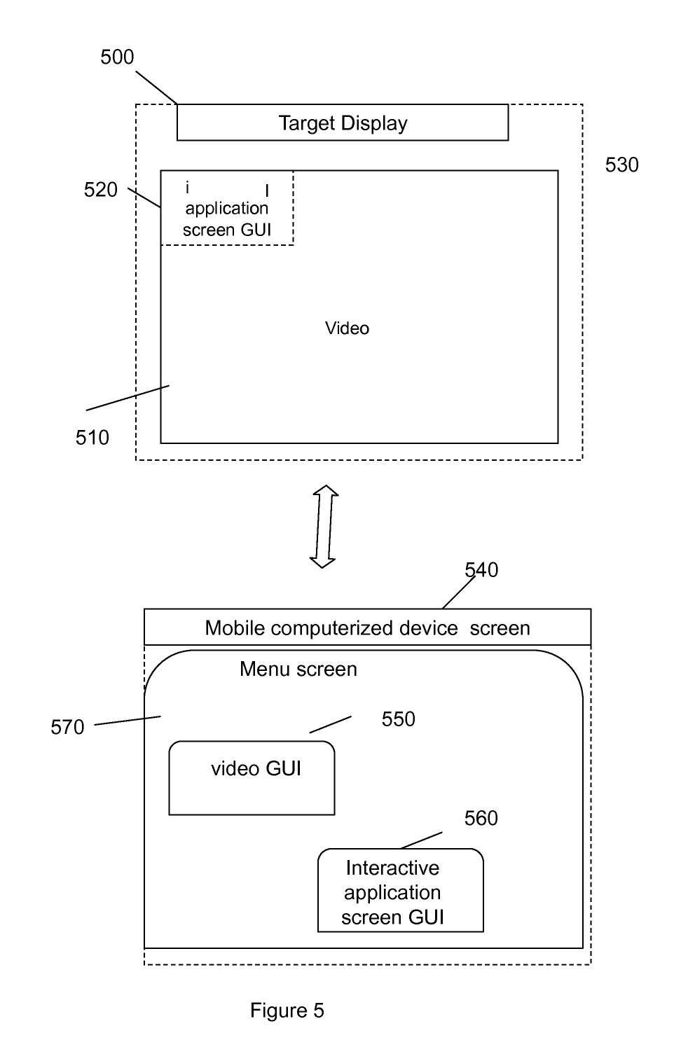

In the following non limiting example, a computerized device is a mobile computerized device. FIGS. 4 and 5 illustrate examples of the screen display on a mobile computerized device display 440 and on a target display 400, according to some embodiments of the invention.

FIG. 4 depicts one option of the layout display on the computerized device menu display and on the target display. On the computerized device display 440 appears a screen menu GUI 460 of the mobile computerized device and the video GUI 450, which is displayed only over a portion of the entire display 460. On the target display 400 appears video 410 in full size and the computerized device menu 430 on a portion of the target display 400 on top of video 410.

FIG. 5 depicts one option of the layout display on the computerized device menu display 540 and on the target display 500. On the computerized device display 540 may appear a menu screen GUI of the computerized device 570 and the video GUI 550. The video GUI 550 may be displayed only over a portion of the display 570 and the interactive application screen GUI 560 as well.

On the target display 500 the video 510 may be displayed in full size and the interactive application screen GUI 520 on a portion of the target display 500. Alternatively, the interactive application screen GUI 520 may be displayed in full size and the video 510 may be displayed on a portion of the target display 500. The interactive application screen GUI 520 and the video 510 may be displayed side by side on the target display 500.

These are examples of optional screen GUI layouts. Other variations may be implemented, such as displaying the video only in a partial area of the target display or displaying interactive widget with the video on the target display.

According to some embodiments of the present invention it is suggested that the design of the screen layout is performed at the computerized device and streamed as it is (with no manipulation) to the target display.

According to some embodiments of the present invention, the application screen data may be streamed from two sources of computerized devices simultaneously, to be displayed on a single target display. Each user of the computerized device may select a different application to be displayed on the single target display or optionally two users may activate the same game application and view combined screen GUI of their game on a single display. The display screen layout management module enables integrating the design layout of two applications in one display according to predefined rules. For example, by default; each Screen GUI may appear on half of the display.

The layout integration rules may be correlated to the functionality and priority of each application. For example, a relatively large portion of the display is designated for an application with a high priority. In case of two users sharing the same game, a single screen of the game can be displayed, integrating gaming data of both participating users. Two streams of game instructions may be received by the target device of the target display from two computerized devices. On each computerized device, actions of the game may be communicated via a GUI of the game that is displayed on each one of the computerized devices.

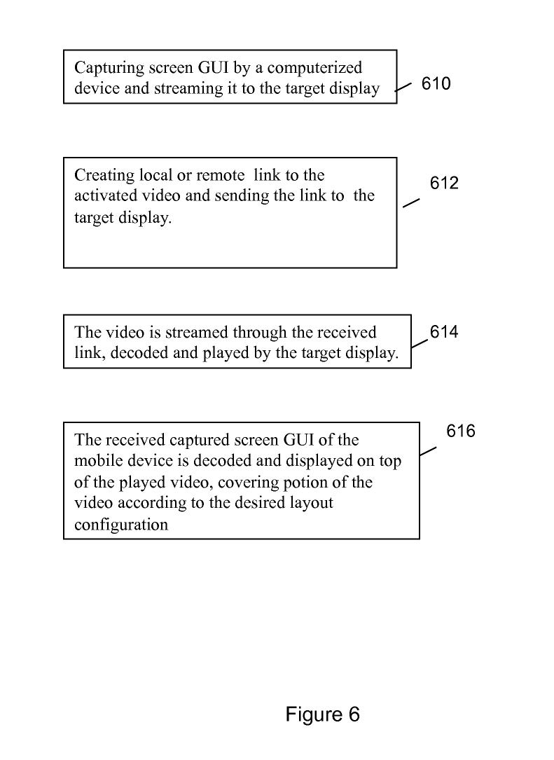

FIG. 6 is a flowchart illustrating a process of combining the computerized device screen GUI and the video by the target display, according to some embodiments of the invention. In a non limiting example, the computerized device is a mobile computerized device. According to this embodiment, the mobile computerized device captures the current active screen GUI of the computerized device (step 610) which may include the computerized device menu or GUI interface of an activated application and streams the screen GUI data to the target display. At the same time, the computerized device may create a local or a remote link of a video that is activated by a user. The link may be transmitted to the target device. For example, a user may activate a video via YouTube or activate a video that is stored locally on the computerized device and the streaming management module may transmit it to the target device of the target display (step 612). In case the video is located remotely, the computerized device may transmit a link of the video that is located remotely. The target device may be connected to a communication network and receive a stream of the video directly from a website where the video was activated.

The created video link is received in the target device of the target display and activated by the target device, by decoding and playing the video (step 614). The received captured screen GUI of the computerized device is decoded by the target device and displayed above the played video, covering portion of the target display according to the desired layout configuration.

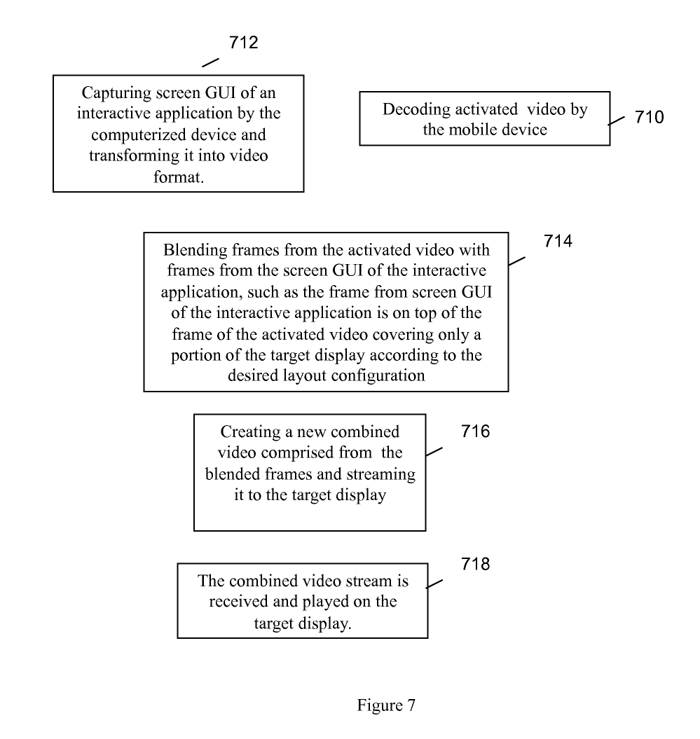

FIG. 7 is a flowchart illustrating a process of combining a computerized device screen GUI and a video by the computerized device, according to some embodiments of the invention. According to this embodiment, the computerized device captures the current active screen GUI of the computerized mobile device (step 712) which may contain the computerized device menu or GUI interface of an activated application and converts the captured image into video format. At the same time, the computerized device decodes the video that was activated by a user (step 710).

Based on the screen GUI video and the decoded activated video a new combined video is created (step 716), comprised of sequence of frames, where each frame is created by blending pairs of frames, one frame of the screen GUI video and one frame from the activated video (step 714) according to a predefined layout configuration. The new combined video stream is transmitted to the target display. The received combined video stream is received and played on the target display (step 718).

According to some embodiments of the invention the streaming application may be implemented for computerized devices running iOS, Android, or any other mobile or non-mobile operating system.

According to some embodiments of the invention the streaming application may be implemented for wireless connection between the computerized device and the target display and may be adapted for Intel's Wireless Display (WiDi) protocol and/or the WFD (Wi-Fi Display) standard.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only. The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element.

It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein. Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method for simultaneous display and activation of at least one video and at least one interactive application on a target display, said method comprises the steps of:
streaming data of at least one computerized device screen menu Graphical User Interface (GUI) to a target device of the target display;
displaying the data of the computerized device screen menu GUI on the target display in a predefined portion of the target display;
activating at least one video;
determining display settings of the at least one video and the at least one computerized device screen menu GUI at the target display;
displaying the at least one video on the target display simultaneously with the at least one computerized device screen menu GUI according to determined settings,
wherein the at least one computerized device screen menu GUI covers a portion of the target display and is displayed above at least one video display.

2. The method of claim 1 further comprising the steps of:
receiving a selection of at least one interactive application from a user;
determining display settings of the video and the at least one interactive application over the target display;
streaming data of the selected one or more interactive applications display to the target device of the target display;
displaying the video stream on the target display simultaneously with the at least one interactive application according to determined settings,
wherein
changing the display portion of the interactive application and video according to triggering events or configuration performed by the user.

3. The method of claim 1, wherein the video is activated by the target device of the target display.

4. The method of claim 1, wherein the video is activated by the computerized device.

5. The method of claim 1, wherein the video is displayed in a partial portion of the target display.

6. The method of claim 1, wherein the video is activated by the computerized device.

7. The method of claim 1, wherein the video is activated by the target device of the target display.

8. The method of claim 1, wherein the video is located remotely and is being streamed directly to the target device via a communication network link.

9. The method of claim 1, wherein the streaming includes blending frames from the activated video with frames from the screen menu GUI, such as the frame from screen menu GUI is on top of the frame of the activated video covering only a portion of the target display according to a predefined layout configuration.

10. A streaming application for simultaneous display and activation of at least one video and at least one interactive application on a target display, said streaming application comprises of:
a streaming management module for streaming data of at least one computerized device screen menu Graphical User Interface (GUI) to a target device of the target display;
an activation module for displaying the data of the computerized device screen menu GUI on the target display in a predefined portion of the target display; and
a display screen layout management module for displaying the at least one video on the target display simultaneously with the at least one computerized device screen menu GUI according to determined settings.

11. The streaming application of claim 10, wherein the streaming application has a user control GUI.

12. The streaming application of claim 10, wherein the activation module is further displaying the video stream on the target display simultaneously with the at least one interactive application according to determined settings, and wherein the at least one interactive application screen is displayed above the video display.

13. The streaming application of claim 10, wherein the streaming management module is further streaming data of the selected one or more interactive applications display to the target device of the target display.

14. The streaming application of claim 9, wherein the display screen layout management module is further changing the display portion of the interactive application and video according to triggering events or configuration performed by a user.

15. The streaming application of claim 9, wherein the streaming management module is further blending frames from the activated video with frames from the screen menu GUI, such as the frame from the screen menu GUI is on top of the frame of the activated video covering only a portion of the target display according to a predefined layout configuration.

16. The method of claim 1, wherein the streaming includes blending frames from the activated video with frames from the screen menu GUI, such as the frame from screen menu GUI is on top of the frame of the activated video covering only a portion of the target display according to a predefined layout configuration.
